(19) United States
(12) Patent Application Publication
(10) Pub. No.: US 2007/0198285 A1
(43) Pub. Date: Aug. 23, 2007

(54) Apparatus and Methods of Advertising Utilizing Photographic Printer Services with Keyword Targeting

(76) Inventors: Richard P. Mottla, Escondido, CA (US); Eric Cardarella, Ladera Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 11/608,122

(22) Filed: Dec. 7, 2006

Related U.S. Application Data
(63) Continuation-in-part of application No. 11/350,354, filed on Feb. 8, 2006.

(51) Int. Cl. G06Q 40/00; G06Q 10/00; G06Q 30/00

(52) U.S. Cl. 705/1; 705/41

(57) ABSTRACT

A method for printing a photographic print including the steps of receiving advertising content from an advertiser; receiving advertiser input from an advertiser associated with the advertising content; receiving image data from a customer; receiving customer input from a customer associated with the image data; comparing the customer input to the advertiser input to generate at least one match; combining advertising content and image data into coupled data based on the generated match; and printing a photographic print, the photographic print including an image section and an advertising section, the photographic print including a printed image printed within the image section, which is based upon the image data of the coupled data, the photographic print further including printed advertising indicia printed within the advertising section, which is based upon the advertising content and related to the customer input. There is also provided a method for advertising and a photographic print.

### CROSS-REFERENCE TO RELATED APPLICATIONS

This application claims the benefit of and is a continuation-in-part of U.S. application Ser. No. 11/350,354 filed Feb. 8, 2006 entitled “Apparatus and Methods of Advertising Utilizing Photographic Printer Services,” the contents of which are wholly incorporated by reference herein.

### STATEMENT RE: FEDERALLY SPONSORED RESEARCH/DEVELOPMENT

Not Applicable

### BACKGROUND

The present invention relates generally to methods of and a device for advertising which utilizes photographic printer services. More particularly, the invention relates to methods of and a device for processing photographic images for end customers which couples the images with advertisements that are related to the images or the interests of the customer based on input provided by the customer.

Advertising is a great way to draw public attention to and promote the goods and/or services of a business. Advertising may be performed through a limitless variety of general mass market advertising formats including cable, radio and television in addition to more specific formats such as sky writing, the back of event tickets, flyers, billboards and bus stop benches. Television, in particular, has always been considered the most effective mass-market advertising format because television viewers tend to provide a captive audience. The general population consists of many avid television viewers, and large numbers of these television viewers have certain favorite television programs that are faithfully watched on a regular basis. Demographic studies are continuously conducted to determine the likes, dislikes, and other lifestyle behaviors of the television viewing audience. Corporations and businesses use this information to advertise during particular time slots of programs, such as during commercial breaks, to reach a specific target audience that is most likely to be interested in their products based on the demographic studies. Television networks respond by charging a premium for the businesses to advertise during the television programs that enable these businesses to reach their target audience.

One problem that is common in many forms of advertising, including television commercials, is that the target audience is not always the viewing audience. In particular, a company may choose to advertise through a certain media outlet that is not favored by the audience it wants to target. Moreover, even if the targeted audience is the viewing audience, the individuals may choose not to view any advertisements, or the individual may only be interested in certain subjects of advertisements. For example, digital video recorders and other similar types of technology enable television viewers to skip over or avoid most, if not all, of the commercial advertising on television. Essentially, technology has destroyed the captive audience, and it has become increasingly more difficult for advertisers to reach their target audience. Additionally, the ability of television viewers to skip commercials has made these viewers adverse to the ever-increasing amount of advertising that occurs during television programming.

The negative trends and attitudes toward advertising are not limited to only television, but they are also present in newspaper, periodical and on-line advertising, which further limits the effectiveness of an advertiser's efforts. One example of advertising falling short of the target audience is illustrated by the multitude of advertisement circulars and brochures commonly found in newspapers. Many people purchase a newspaper on a regular basis so that they may keep abreast of current events occurring in the world, Businesses pay substantial sums of money to produce advertising circulars and other brochures which are included with the newspaper and often contain valuable savings for the target audience. However, the average consumer is so inundated with advertising circulars and other brochures that the consumer may choose not to view the advertising material. In addition, the advertisements are provided to the general public, which may be a group that does not include the target audience. In yet another example, many traditional advertisers are finding it increasingly difficult to compete with pop-up and banner ads that are used in online advertising. However, even much of the online advertising is ignored by the average consumer. Consumers find banner and pop-up advertisements annoying and many click them away, if possible.

In short, investment dollars spent on current methods of advertising are producing diminishing returns. Therefore, advertising has been found to be more effective when the consumer chooses to be part of the target audience by providing input to facilitate the receipt of subjects of advertising material desired by the consumer. Accordingly, businesses and consumers could all benefit from an innovative alternative to the current methods of advertising.

One untapped method of advertising involves photography and photographic printer services. Traditionally, customers have taken their rolls of film to a retail photographic printer service for development. The printer service develops the unexposed film and provides the customer with a multiplicity of printed photographic images that represent the information originally contained on the roll of film. Technological advances in photography have resulted in the widespread use of digital cameras and home printing devices which have caused a substantial reduction in prints made at retail. Understandably, all retail photographic printer services may presumably be interested in an opportunity to entice their customers away from home printing devices and back to the retail photographic processing service outlets.

Retail photographic printer services, in addition to consumers and advertisers, could benefit from an innovative alternative to the current advertising model that provides advertising content to customers of photographic printer services. A business method which shifts the payment for the material and labor costs associated with processing photographic prints from the customer to an advertiser would enable retail photographic printer services to achieve economies of scale. Currently, photographic printer services charge customers for the development of their photographic images, which may be processed from either traditional film or digital media. This business model barely covers the costs of material and labor associated with the printing of standard photographic prints by these printer services because of the overall decrease in utilization of the service. However, an increase in the volume of photographic prints processed by the retail printer service for customers would reduce the associated per print material and labor costs. At the same time, customers would have an incentive to use the services of the photographic printer service at little or perhaps no cost in exchange for the receipt of valuable advertising that is directed to the articulated interests of the consumer.

Accordingly, there is a need in the art for improved methods and a device for providing advertising content, based on consumer input, in connection with photographic printer services and processed photographic images as a way to reach customers.

### BRIEF SUMMARY

According to an aspect of the present invention, there is provided a method for printing on a photographic print. The method includes the step of receiving advertising content from an advertiser. The method further includes the step of receiving advertiser input from an advertiser that is associated with the advertising content. The method further includes the step of receiving image data from a customer. The method further includes the step of receiving customer input from a customer that is associated with the image data. The method further includes the step of comparing the customer input to the advertiser input to generate at least one match. The method further includes the step of combining the advertising content and the image data into coupled data based on the generated match. The method further includes the step of printing a photographic print, wherein the photographic print includes an image section and an advertising section, the photographic print further including a printed image printed within the image section, the printed image being based upon the image data of the coupled data, the photographic print further including a printed advertising indicia printed within the advertising section, the printed advertising indicia being based upon the advertising content and related to the customer input.

This method for advertising is innovative in its coupling of advertising content with a customer's image data on a photographic print. Accordingly, the advertising method described may serve the purpose of enabling a photographic print to serve as an advertising medium wherein the customer provides customer input to facilitate the receipt of desired subjects of advertisements.

According to the various embodiments of the invention, the advertiser input is at least one of a keyword, a group of words or a phrase and the advertising content provided by the advertiser is associated with the advertiser input. The advertiser input further describes the image data with which the advertising content should be associated. The image data may contain more than one image and the customer input may be associated with each individual image. The customer input may be associated with the image data at any time before the image data is submitted to the printer service. If the customer is providing the image data and the customer input to the printer service over a global electronic network, the customer input may be created by the customer or the customer input may be selected from a subject tree. The customer input may further include demographic information about the customer including lifestyle, interests, family data and personal data. The customer may further create a user profile that is retained by the printer service with which image data and customer input is associated when subsequent photographic prints are created. The user profile may comprise a compilation of customer input over a period of time that details the interests and lifestyle of the customer.

According to another aspect of the present invention, there is provided a method for advertising on a photographic print. The method includes a step of identifying a printer service, the printer service providing printing services to customers, each customer providing the printer service with image data and customer input that describes the content of the image data for the printer service to print photographic prints that include printed images derived from the image data. The method further includes a step of providing advertising content to the printer service, the advertising content being representative of advertising indicia. The method further includes a step of providing advertiser input to the printer service, the advertiser input associated with the advertising content. The method further includes a step of requesting the printer service to compare customer input to the advertiser input to generate at least one match; combine the advertising content and the image data into coupled data based on the generated match; and print a photographic print, the photographic print including a printed image and an advertising indicia wherein the printed advertising indicia is based upon the advertising content and related to the customer input.

This method for advertising is innovative in its coupling of advertising content with a customer's image data on a photographic print. Accordingly, the advertising method described may serve the purpose of utilizing a photographic print as an advertising medium wherein the customer provides input to facilitate the receipt from the advertiser of advertising content that is related to the customer's interests.

According to another aspect of the present invention, there is provided a photographic print. The photographic print includes a photographic paper stock, which has an image section and an advertising section. The photographic print also includes a printed image printed within the image section. Finally, the photographic print includes a printed advertising indicia printed within the advertising section that is related to the printed image.

This photographic print is innovative in that it contains advertising content coupled with a customer's image data. Accordingly, the photographic print device may serve as an alternative advertising medium for advertisers because the customer chooses to identify itself as a member of the target audience by providing input to facilitate the receipt of subjects of advertising material desired by the customer.

### BRIEF DESCRIPTION OF THE DRAWINGS

An illustrative and presently preferred embodiment of the present invention is shown in the accompanying drawings in which:

FIG. 1 is a schematic diagram illustrating interaction between an advertiser, a customer, and a printer in printing a photographic print.

FIG. 2 is a representation of a web page for uploading image data and customer input according to an aspect of the present invention.

FIG. 3 is a flow chart of a method for printing on a photographic print according to an aspect of the present invention.

FIG. 4 is a relational diagram representing the comparison of customer input to advertiser input and the association of related advertising content to the images contained within the image data.

FIG. 5 is a flow chart of a method for advertising on a photographic print according to another aspect of the present invention.

FIG. 6 is a schematic diagram of a first embodiment of a printer device capable of utilizing the printing and advertising methodologies in producing a photographic print, and a first embodiment of a photographic print.

FIG. 7 is a schematic diagram of a second embodiment of a printer device, wherein the image data storage unit and advertising data storage unit are included in a single storage device.

FIG. 8 is a schematic diagram of a third embodiment of a printer device, wherein the image data storage unit, advertising data storage unit, and coupled data storage are included in a single storage device.

FIG. 9 is an exploded view of a second embodiment of the photographic print, wherein the image section is non-overlapping with the advertising section.

FIG. 10 is an exploded view of a third embodiment of the photographic print, wherein the line indicia is a dashed line.

FIG. 11 is an exploded view of a fourth embodiment of the photographic print, wherein the advertising section is detachable from the image section.

FIG. 12 is an exploded view of a fifth embodiment of the photographic print, wherein the photographic paper stock includes a perforation.

FIG. 13 is an exploded view of a sixth embodiment of the photographic print, wherein the photographic paper stock includes a crease.

### DETAILED DESCRIPTION

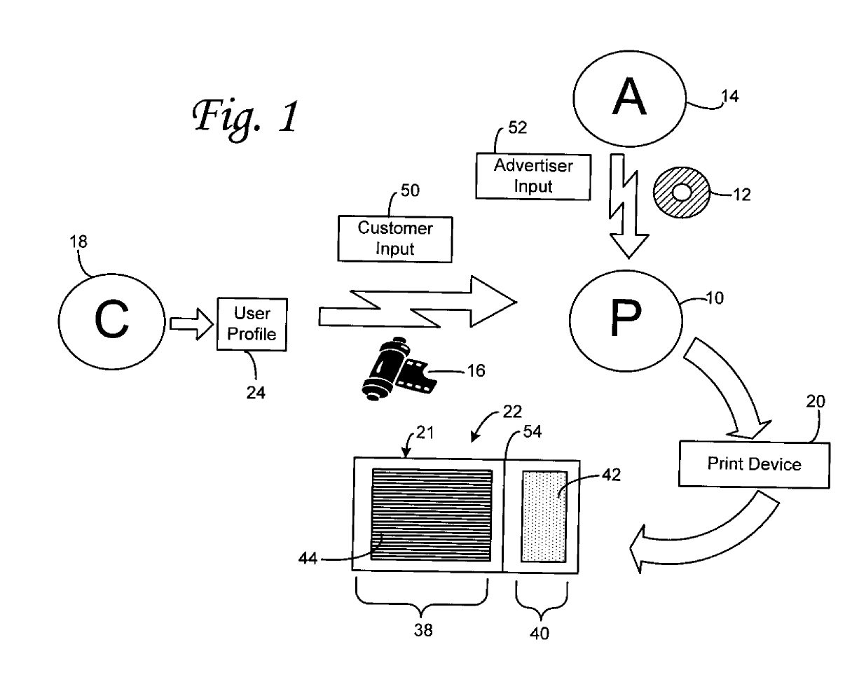

The drawings referred to herein are for the purposes of illustrating the embodiments of the present invention and not for the purposes of limiting the same. FIG. 1 is a general schematic view of the methodology for the coupling of image data 16 and advertising content 12 wherein the customer provides customer input 50 which is compared to and matched with advertiser input 52 to facilitate the receipt of certain subjects of advertising content 12 in connection with a photographic print 22.

As used herein, customer input 50 may include keywords, groups of words and phrases that are provided by the customer 18 to describe the image data 16, content of the image data 16 and other demographic data that may be provided by the customer 18. The customer input 50 may be in the form of words, responses to a series of prompts or a keystroke. The customer input 50 includes descriptive words or phrases that describe the characteristics or features of the image data 16 such as where the image data 16 was captured; the subject of the image contained within the data 16 or the objects or people pictured in the images contained within the image data 16. Similarly, advertiser input 52 as used herein may include keywords, groups of words and phrases that are provided by the advertiser 14 and which describe its advertising content 12 and the image data 16 or content of image data 16 with which the advertising content 12 should be coupled, as further described.

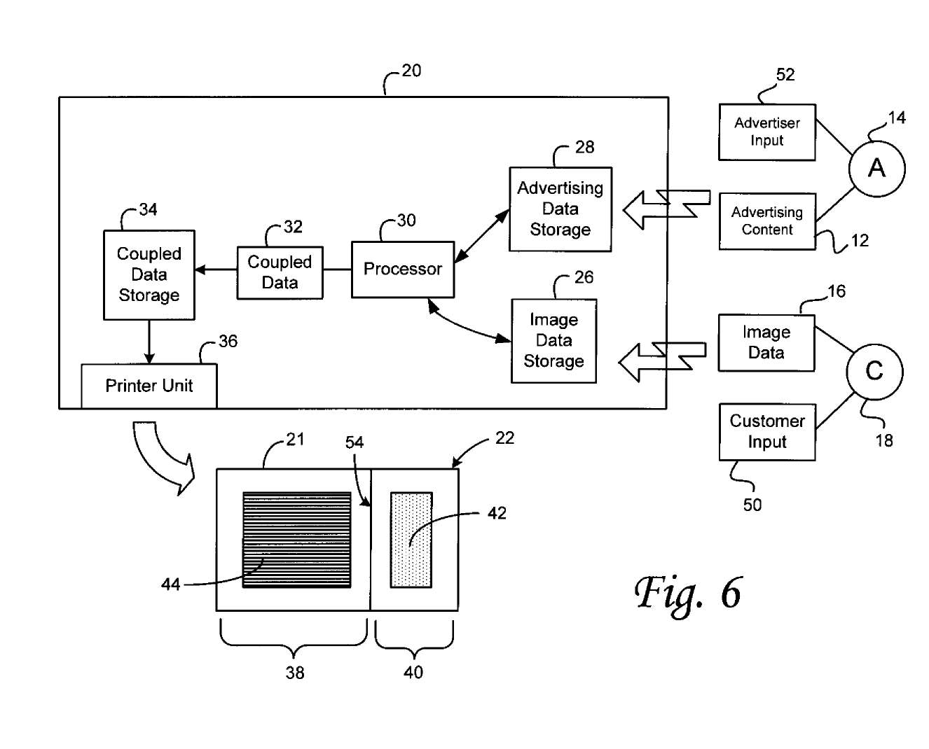

The advertiser input 52 is compared with the customer input 50 to generate at least one word or phrase match. Pre-designed advertising content 12 is associated with the advertiser input 52 which is then is coupled with the appropriate image data 16 based on the generated matches between the customer input 50 and the advertiser input 52. The end product is a photographic print 22 which may include any combination of image data 16 and advertising content 12. The photographic print 22 is printed onto photographic paper stock 21 and comprises a printed image 44 located within an image section 38 and a printed advertising indicia 42 located within an advertising section 40. Examples of the manner in which a photographic print 22 is created and exemplary systems that can be used in the innovative coupling of the image data 16 with the advertising content 12 are represented and described in FIGS. 6 through 8. The appearance of the photographic print 22, as the end product of the coupling of the image data 16 and the advertising content 12, is depicted in various embodiments described in FIGS. 6 and 9 through 13

Referring to FIG. 1, the image data 16 is provided by the customer 18 to the printer service 10. The image data 16 may include any form of an image that is capable of being processed into the photographic print 22. For example, in FIG. 1, the customer 18 may provide image data 16 to the printer service 10 for processing that is in the form of a roll of film. The most common type of film used in an average customer's camera is 35 mm film. The rolls of film provided by the customer may also include any other available type of film that is capable of being processed according to the methodology described herein, including APS, 110, 126, 127, 120/220, sheet film, disc film, and motion picture film. The customer 18 may also provide image data 16 in the form of a negative, which is photographic film that has already been processed to produce photographic prints, or the customer may provide previously processed photographic prints. The printer service 10 may need to convert the image data 16 into an electronic format, depending on the type of the image data 16 provided by the customer 18. The conversion may be done utilizing methods known to one skilled in the art, such as scanning and the like.

The image data 16 may already be in an electronic format when presented to the printer service 10. For example, the customer 18 may capture images with a digital camera, and the image is stored in an electronic format on a memory card, data disk or other similar image storage media. Depending on the type of storage media used by the customer 18 to capture the image, the image format may be digital or analog, each of which may be processed by the printer service 10. The customer 18 can provide the memory card, data disk, or other image storage media containing the analog or digital image data 16 to the printer service 10 for processing into the photographic print 22 in connection with a printer device 20.

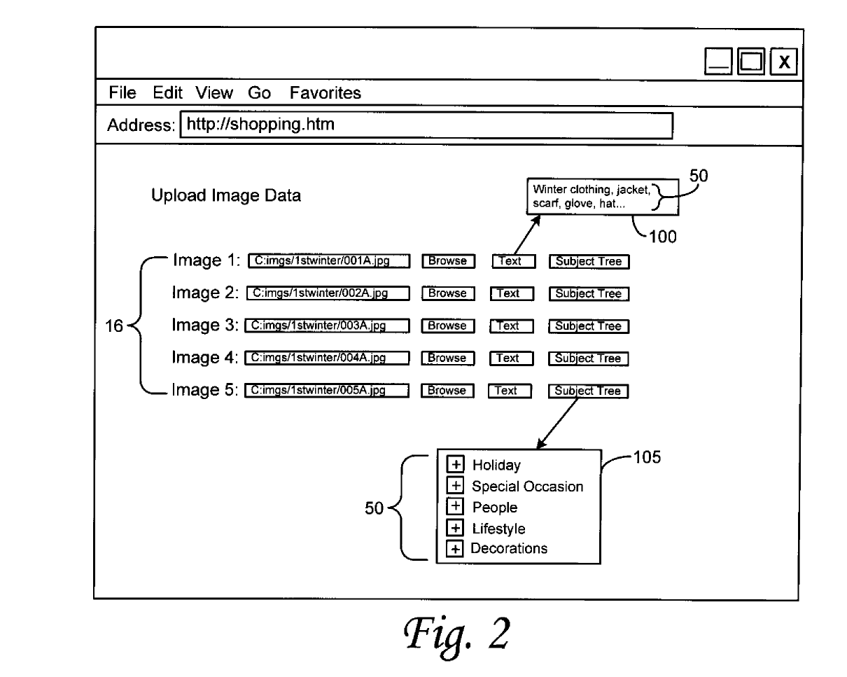

In addition to the image data 16 provided by the customer 18, the customer 18 is asked to provide customer input 50 which is related to the image data 16 or the demographic information of the customer 18, such as lifestyle, interests and hobbies. FIG. 2 represents an embodiment of a web page through which a customer 18 can provide image data 16 and customer input 50. Referring to FIGS. 1 and 2, each individual keyword, group of words or phrase of the customer input 50 may be individually created and provided by the customer 18 by typing the same into a textbox 100, or the web site may contain a subject tree 105 that the customer 18 can narrow down through the subjects to select related customer input 50 without having to personally provide the same. If the customer input 50 is selected through a subject tree 105, the category selections may be limited by the structure of the subject tree. For example, the printer service 10 may choose to provide for available customer input 50 only the customer input 50 that correlates to the image data 16 most frequently processed by the printer service 10. In an alternative embodiment, the customer 18 may provide customer input 50 through answering questions or other prompts that are presented to the customer 18 by way of inputting a character response, such as a checkmark in a box, or by providing a computer stroke, such as a carriage return.

Regardless of the method used to provide the customer input 50, the customer 18 may associate customer input 50 with each image contained within the image data 16 or the customer 18 may associate customer input 50 with a group of images or the complete set of images contained within the image data 16. If the customer 18 provides image data 16 and customer input 50 over the internet in connection with a web site, the customer 18 can provide the customer input 50 about the image data 16 at any time before or during the uploading of the image data 16. Thus, the customer 18 may provide the customer input 50 immediately prior to uploading the image data 16 to the printer service 10 or when each image contained in the image data 16 is selected for uploading to the printer service 10.

For example, if the customer 18 is providing the information to the printer service 10 over the internet in connection with a website, the website may be structured such that a textbox 100 is provided in conjunction with each image of the image data 16 wherein the customer 18 may enter customer input 50. Alternatively, the website may be designed such that a single textbox 105 may be provided where the customer input 50 may be typed for the group of images contained within the image data 16. Once the desired images are selected for uploading to the printer service 10, the images contained within the image data 16 are resized for four inch by six inch photographic print resolution to speed the uploading process. The image data 16 is sent to the printer service 10 along with the customer input 50, as further described herein. In another embodiment, the customer 18 may download a computer program, such as a Java applet, that is configure to enable the customer 18 to search the computer for image data 16. The computer program causes a special folder to be created into which each selected image of the image data 16 may be temporarily stored for subsequent uploading and additionally resized to an appropriate resolution for a four-inch by six-inch photographic print for subsequent uploading. Again, the customer 18 can provide the customer input 50 at any time prior to or during the uploading of the image data 16.

In one example for which customer input 50 may be provided, the subject of the image data 16 may be associated with the first experience for an infant or toddler of playing in the snow. The customer input 50 may be directed to the cold weather and include keywords such as winter clothing, jacket, coat, scarf, glove, hat or mitten in addition to other words that are directed to small children, generally, such as diapers, baby food and other similar terms. In another example, the image data 16 may contain a man and his Labrador retriever in the yard playing a game of fetch. The customer input 50 may be directed to pets that includes words such as pet toys, chew stick, ball, large dog, and Labrador retriever or other words generally directed to the outdoor area of a home, such as yard and grass. Further, the customer 18 may be asked to provide additional customer input 50 such as demographic information about themselves, their families, or their lifestyle interests or hobbies. For example, the customer 18 may provide customer input 50 related to at least one of age, family size, household income, address, leisure activities, profession, education and type of car.

In one embodiment, the customer 18 may create a user profile that is retained by the printer service 10. Accordingly, if the customer 18 submits the image data 16 and customer input 50 to the printer service 10 through a web site over the internet, the printer service 10 may first require the customer 18 to create a log in by supplying a user name and a password. The user name and password can be any combination of letters and/or numbers, as is well known in the art. When the customer 18 creates the user profile, the customer 18 may also supply customer input 50 in the form of demographic information, as previously described, which can be saved to the user profile and updated from time to time on a voluntary basis by the customer 18. The user profile may also be created at a retail site of the printer service 10 if the customer provides the image data 16 and customer input 50 in any manner other than over a global electronic network. In this regard, the customer 18 would provide verbal or written information to the printer service 10 for the creation of a user profile that would be stored in an appropriate data storage device for later access during subsequent processing of photographic prints 22, as further described herein. The user profile may be later accessed at the retail site of the printer service 10 such as by the scanning a bar code printed on a customer card. Once the user profile has been created, the customer 18 may associate and submit each subsequent set of image data 16 with the user profile. Each time that the customer 18 provides input 50 in connection with subsequently submitted image data 16, the input 50 may be associated and stored with the user profile. Over time, the user profile of the customer 18 could contain a detailed list of customer input 50 that is related to the interests, lifestyle and habits of the customer 18 and which can be accessed to provide advertising content 12 for subsequently processed photographic prints 22. Other information in the user profile that may be used as input 50 includes the mailing address of the customer 18 or the shipping address of the photographic prints. For example, a customer 18 may specify that the photographic prints 22 be sent so someone other than the customer 18, such as an uncle in Florida, Calif. In such a case, “Florida” may be used as a keyword for targeting the advertising content 12, such as a coupon for suntan lotion.

In one embodiment, the customer 18 submits the image data 16 and the input 50 to the printer service 10 in the form of a digital file. The customer input 50 is contained within the digital file in the form of metadata that may be associated with at least one image contained within the image data 16, depending on the method by which the customer 18 has provided the customer input 50. Specifically, the customer input 50 may be stored as metadata that is associated with a particular image or images that are being uploaded or the metadata may be stored as one string of words and phrases that is associated with the entire digital file. In another embodiment, the customer 18 may provide the customer input 50 in a retail setting in a verbal or written format. The printer service 10 can manually enter the customer input 50 into a database with the associated images contained within the image data 16.

In FIG. 1, the advertiser 14 provides advertising content 12 to the printer service 10. Advertising content 12 may include any form of content, including images and data, provided by the advertiser 14 to the printer service 10 for processing with the image data 16 into a photographic print 22. The advertising content 12 should promote the goods or services of the business in some manner. Referring to FIG. 1, the advertising content 12 may for example be provided by the advertiser 14 to the printer service 10 on a roll of film for processing with the image data 16 as the photographic print 22. Alternatively, the advertising content 12 may be provided by the advertiser 14 to the printer service 10 in an electronic format, such as on a memory card used in digital cameras. The advertiser 14 may also provide advertising content 12 in the form of a previously processed photograph, or any type of image, on plain paper stock to the printer service 10 for scanning and conversion of the advertising content 12 into an electronic format.

In addition, the advertiser 14 can supply the printer service 10 with advertiser input 52. Individual advertisements contained within the advertising content 12 are associated with specific keywords, groups of words and phrases of the advertiser input 52. The print device 20, as further described herein with respect to FIGS. 6 through 8, contains the appropriate software and equipment to compare the advertiser input 52 with the customer input 50 and common matches are generated between the two sources of input. Pre-designed advertising content 12, which is associated with the keywords, groups of words or phrases of the advertiser input 52 and which matches the customer input 50 provided by the customer 18 with regard to the image data 16, is coupled with the appropriate image data 16 based on the generated matches.

The printer device 20 prints the end product of this process which is a photographic print 22 comprising a printed image 44 coupled with printed advertising indicia 42, with the printed advertising indicia 42 being related to one of the printed image 44 or the demographic information of the customer 18 based on the customer input 50. The printed advertising indicia 42 may include without limitation, the identification of a merchant, a product mark or brand name, a product description, or an advertising coupon, such as a cents-off coupon or a promotional giveaway.

The photographic print 22 is printed on photographic paper stock 21 may include any type of physical object onto which the printed image 44 and printed advertising indicia 42 may be printed. The photographic paper stock 21 may include traditional photographic paper capable of undergoing chemical development processes to produce a glossy or matte photograph. The photographic paper stock 21 may also be any product whose surface is capable of absorbing an ink or printing material. For example, the photographic paper stock 21 may be traditional paper, such as an 8½×11 inch sheet of paper capable of absorbing toner from a standard laser printer. The photographic paper stock 21 may also include various types of heavier paper stock, such as card stock or cardboard. The photographic paper stock 21 may be formed of organic or inorganic materials and the photographic paper stock 21 may also be coated.

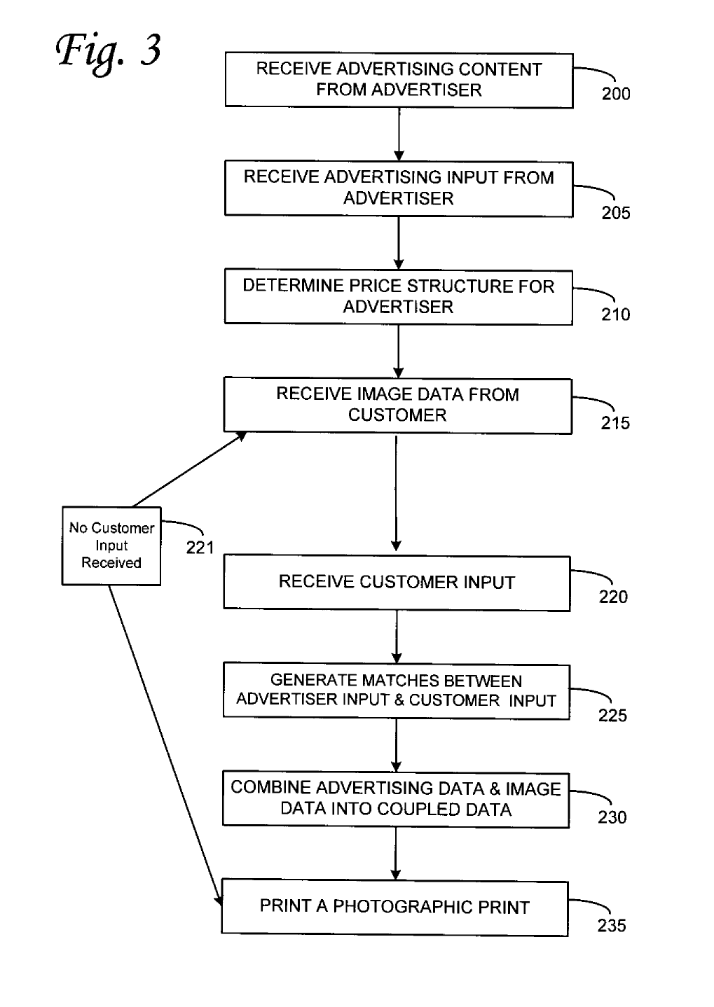

Referring now to FIGS. 1 and 3, there is depicted a flow diagram indicating steps of a method for printing the photographic print 22 from the perspective of the printer service 10. Initially at step 200, the printer service 10 receives advertising content 12 from at least one advertiser 14. As previously described, the advertising content 12 may be any type of content that can be presented to the customer 18 in connection with a photographic print 22 which promotes the goods or services offered by the advertiser 14. In addition to receiving the advertising content 12, at step 205 the printer service 10 receives advertiser input 52 regarding the particular subjects and content of the image data 16 with which the advertiser 14 wants to associate the advertising content 12 in the form of the photographic print 22. The advertiser input 52 may be provided to the printer service 10 in any format including electronically, such as through email or through a global electronic network. For example, the advertiser 14 may upload advertising content 52 and advertiser input 12 in a manner similar to the manner in which the customer 18 uploads customer input 50 and image data 16. The advertiser input 52 may further be provided in a verbal or written format which may require manual input by the printer service 10

At step 210, the printer service 10 may determine a price structure so that each advertisement may be priced based on demand. For example, more than one advertiser 14 may want to advertise on the same exact keyword or phrase of the customer input 50. In one embodiment, the printer service 10 may have two different price structures such that the printer service 10 may charge a premium to advertise on an exact match of a keyword or phrase where two or more advertisers 14 want to advertise on the exact same keyword or phrase of the customer input 50. Accordingly, the advertiser 14 that is selected to advertise on an exact match of the customer input 50 may pay a higher price to have its advertising content 12 selected for printing on a photographic print 22. Alternatively, the printer service 10 may utilize a bidding process to determine the advertising content 12 that receives the most exposure, as between competing advertisers 14. For example, the printer service 10 may provide an auction style bidding process for an advertiser 14 to receive number of matches with regard to advertising content 12 in exchange for a monetary bid. Thus, the winner of the auction may receive the first number of matches for advertising content 12 that matches the customer input 50 when the printer service 10 is generating matches between the advertiser input 52 and the consumer input 50 for the image data 16. Each of the remaining bidders may receive the next number of matches that are generated with each advertiser 14 ranked in descending order depending on the amount of the posted bid.

At step 215, the printer service 10 receives the image data 16 from the customer 18 in any format as described with respect to FIG. 1. At step 220, the printer service 10 may receive customer input 50 from the customer 18. The printer service 10 may receive the image data 16 and customer input 50 by any available methodology, including without limitation over a global electronic network, such as the internet, or directly from the customer 18 at a retail location.

It is contemplated that photographic printing printer services for the processing of image data may be offered to the customer 18 according to certain pricing levels. Accordingly, at step 221, the customer 18 may elect not to provide any customer input 50. The customer 18 would not receive any advertising content 12 with the final photographic prints 22. Thus, the printer service 10 may offer a first pricing level for the photographic print 22 which includes printed advertising indicia 42 and a second pricing level that does not include the printed advertising indicia 42. As a further alternative embodiment, the printer service may offer a first pricing level for the photographic print which is less than the second pricing level. This embodiment may further include an offer to the customer 18 by the printer service 10 wherein the first pricing level does not charge the customer 18 for the photographic print 22 in exchange for the customer 18 electing to provide customer input 50 and subsequently receiving advertising content 12.

At step 225, the printer service compares the advertiser input 52 to the consumer input 50 to generate matches. In connection with an appropriate software program contained on the processor 30 of the printer device 20, as described in FIGS. 6 through 8, the customer input 50 may initially be compared to a dictionary of typical words and phrases to verify the accuracy of spelling or a natural language engine may be used to determine the validity of a phrase. Additionally, a text extrapolation technique may be utilized in which the customer input 50 is compared to a database, table or other relational data structure that relates the customer input 50 to other words, such as synonyms, which generates additional related keywords or phrases. In this regard, keyword and phrase concepts may be expanded to include (i) variations and corrections of the keywords and/or phrases and (ii) related words that can broaden the scope of the advertising content 12 that may be received by the customer 18.

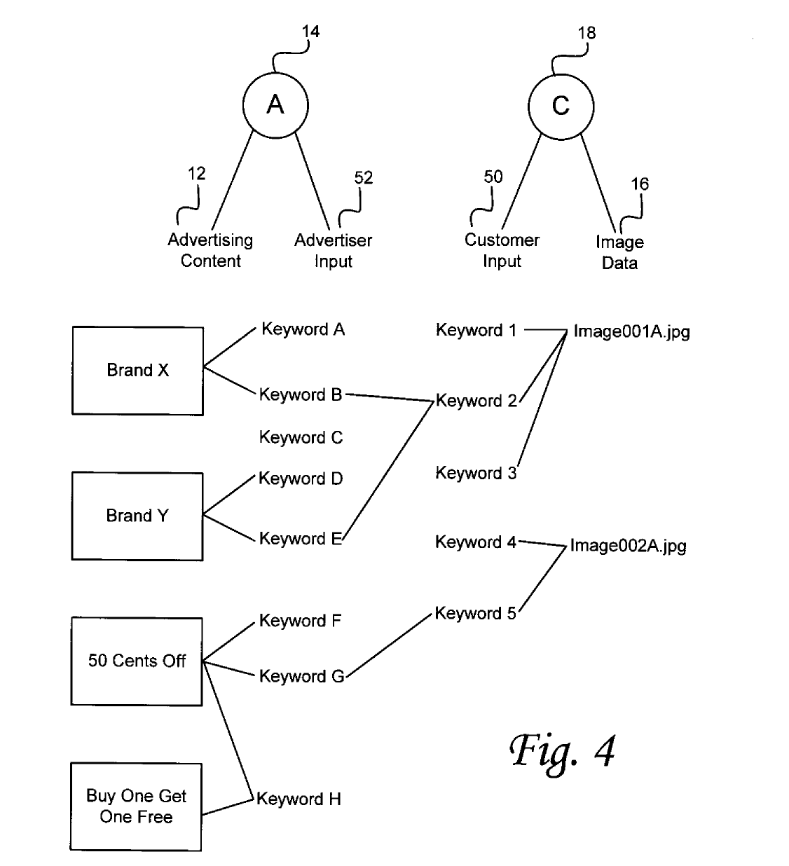

Referring to FIG. 4, each of the keywords and phrases contained within the advertiser input 52 is associated with certain advertising content 12, as provided by the advertiser 14. When the keywords and phrases of the advertiser input 52 are compared to the keywords and phrases of the customer input 50 that is associated with the images contained within the image data 16 provided by the customer 18, a match may be generated based on the keywords and phrases that are common between the customer input 50 and the advertiser input 52. Based on the matches generated from the comparison of the advertiser input 52 and the customer input 50, a selection of advertising content 12, which is related to the image data 16 based on the customer input 50, is generated for coupling with the image data 16 to form a photographic print 22.

In FIG. 4, the customer 18 has provided image data 16 which includes Image001A and Image002A. Specifically with regard to Image001A, the customer 18 has provided customer input 50 that includes Keyword 1, Keyword 2 and Keyword 3 which are compared to the advertiser input 52 provided by at least one advertiser 14. Keyword 2 of customer input 50 matches Keyword B and Keyword E of advertiser input 52. Keyword B is associated with advertising content 12 that contains some form of advertisement related to Brand X and Keyword E is associated with advertising content 12 that contains some form of advertisement related to Brand Y. Advertising content 12 related to either Brand X or Brand Y may be selected for coupling with the image data 16 to form a photographic print 22. Again referring to FIG. 4 and specifically with regard to Image002A, the customer 18 has provided customer input 50 that includes Keyword 4 and Keyword 5 and which are compared to the advertiser input 52. Keyword 5 of customer input 50 matches Keyword G of advertiser input 52. Keyword G is associated with advertising content 12 that contains an advertisement having a fifty cents off coupon which is selected for coupling with the image data 16 to form the photographic print 22.

At step 230, the printer service 10 combines the advertising content 12 provided by the advertiser 14 and the image data 16 provided by the customer 18 to produce coupled data 32. Finally, at step 235, the printer service 10 processes the coupled data 32 and prints a photographic print 22 on photographic paper stock 21. The photographic print 22 includes a printed image 44 and a printed advertising indicia 42. Thus, the printed advertising indicia 42 is printed with an advertising section 40 and is based upon the advertising content 12 found in the coupled data 32. The photographic print 22 further includes a printed image 44 printed within the image section 38, which is based upon the image data 16 found in the coupled data 32. With regard to FIG. 4, Image001A should result in a photographic print 22 having a printed advertising indicia 42 related to either Brand X or Brand Y and Image002A should result in a photographic print 22 having a printed advertising indicia 42 that is a coupon for fifty cents off the purchase of a product or service, as represented by FIGS. 6 and 9 through 13.

Step 235 of the printing method may include the printing of the photographic print 22 by the advertiser 14 rather than by a printer service 10. Step 235 may further include the charging of a fee to the advertiser 14 by the printer service 10 for the inclusion of printing advertising indicia 42 in the photographic print 22. Step 235 may further include not charging any fee to the customer 18 for the printing of a photographic print 22. Step 235 may alternatively include the charging of a fee to the advertiser 14 for the costs incurred by the printer service 10 in the printing of the photographic print 22.

When utilizing this type of advertising, the printer service 10 may pass the substantial cost savings to the customer 18 by shifting the cost burden to the advertiser 14, as the advertiser 14 should benefit from this unique process of coupling of image data 16 with advertising content 12 that is related to at least one of the image data 16 and the customer input 50 to form a photographic print 22. The printed image 44 is coupled with the printed advertising indicia 42 on the photographic print 22. The customer 18 and anyone else who may view the photographic print 22 with the printed advertising indicia 42 intact are a captive audience which are exposed to the printed advertising indicia 42 of the advertiser 14. This in turn enables creative advertising methods whose implementation may pass on substantial cost savings to the printer service 10 and customer 18 alike. It is contemplated that the advertiser 14 would be willing to pay for the costs associated with such a unique advertising channel. This will enable the printer service 10 to benefit from the economies of scale resulting from the mass production of photographic prints 22 containing some printed advertising indicia 42 paid for by the advertiser 14. Further, the customer 18 may benefit from a multi-tiered pricing structure for photographic prints 22 which contain printed advertising indicia 42 that are related to the articulated interests of the customer 18. The customer 18 may gain valuable savings by providing the information that makes them part of the target audience based on their input.

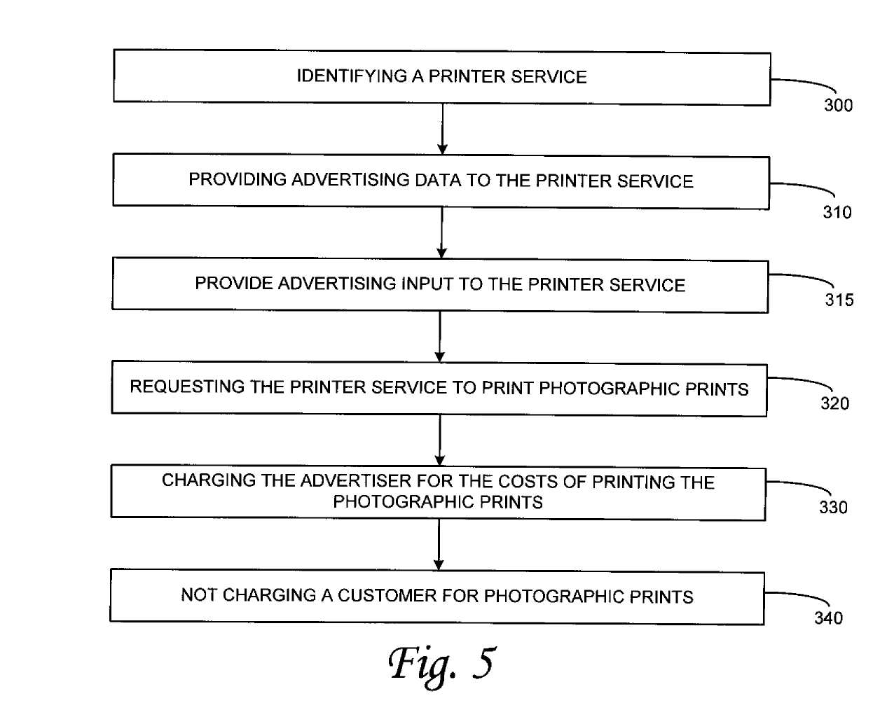

Referring now to FIG. 5, there is depicted a flow chart of aspects of the present invention which, according to an aspect of the present invention, provides a method for advertising utilizing photographic printer services. In this regard, this aspect of the present invention is from the perspective of the advertiser 14. At step 300, the advertiser identifies a printer service 10 that provides printing services to customers 18 who provide image data 16 for processing into a photographic print 22. The method further comprises a step 310 of the advertiser 14 providing advertising content 12 to the printer service. The method further comprises a step 315 of providing advertiser input 52 to the printer service 10. The method additionally comprises a step 320 of the advertiser 14 requesting the printer service 10 to print a photographic print 22, which includes the printed advertising indicia 42 provided by the advertiser in the advertising section 40 coupled with the printed image 44 derived from the image data 16 provided by the customer 18, which is printed in the image section 38. The customer input 50 associated with the image data 16 matches the advertiser input 52 associated with advertising content 12 which further corresponds to the printed advertising indicia 42.

Step 330 may include the printer service 10 charging the advertiser 14 for the costs of printing a photographic print 22 which incorporates the advertiser's printed advertising indicia 42. This step contemplates a pricing structure and payment by the advertiser 14, as described in FIG. 3, including circumstances when more than one advertiser wants to advertise on an exact match of the customer input 50. Step 340 may include the printer service 10 not charging the customer 18 for photographic prints 22 whose costs have been paid for by the advertiser 14 in step 330.

This advertising method may be especially useful to an advertiser 14 of retail goods or services that elects to incorporate an in-house printer service 10. In so doing, a multi-service and product advertiser such as a large retailer may be able to implement this method by coupling the printed image 44 processed for customers 18 by the in-house printer service 10 department with printed advertising indicia 42 promoting goods or services in its other departments. For example, the advertiser 14 may print the photographic print 22 such that it includes printed advertising indicia 42 which advertises a sale on items that are related to the customer's interests based on the customer input 50. For example, printed advertising indicia 42 may be provided on a photographic print 22 for a customer 18 regarding a sale on high-definition flat screen television sets in the consumer electronics department or a sale on all-terrain tires in the automotive department if that customer 18 has indicated an interest for such advertising content based on the customer input 50 that they have provided. In having adopted this advertising method, the advertiser 14 is able to off-set a part of its advertising budget by the in-house printer service 10, while at the same time insuring that their advertising indicia 42 is read by a captive audience that may have a genuine interest in the goods and/or services.

Having provided the customer 18 in various embodiments with the multi-tiered pricing levels for the purchase of photographic prints 22, the customer 18 is empowered with the freedom of choice of the printed advertising indicia 42 to which they are exposed, or if they want to be exposed to printed advertising indicia 42 at all. As has been discussed herein, television viewers have restricted choices when it comes to deciding whether they wish to view commercials which interrupt their desired programming. At best, a digital video recorder or some subscription services enable television viewers to reduce their time spent viewing television commercials. However, they cannot be avoided altogether. With one embodiment of this advertising method, by providing an economic incentive to view printed advertising indicia 42 that is based on advertising content 12 matching the interests of the customer 18, the customer 18 should be motivated to pay attention to the personalized advertising indicia which would have otherwise been ignored. Alternatively, the customer 18 may choose to pay a higher price for photographic prints 22 that do not contain advertising indicia 42. For example, if the printer service 10 offers a first pricing level for photographic prints 22 containing printed advertising indicia 42 which is 50% less than the second pricing level which contains no printed advertising indicia 42, the customer 18 will clearly have an economic incentive to choose the first pricing level. Under such circumstances, the customer 18 may appreciate the fact that they are given a choice as to whether they wish to view advertising indicia and the ability to provide input into the advertising indicia that are included with the photographic prints 22. The customer 18 may be especially incentivized to view photographic prints 22 containing printed advertising indicia 42 if the first pricing level for the photographic print 22 is set at no charge to the customer 18. Depending on their preferences, the customer 18 may elect to use the printer service 10 which only offers photographic prints 22 that contain printed advertising indicia 42.

In an embodiment where the advertiser 14 has an in-house printer service 10, a multi-tiered pricing system may allow the advertiser 14 to decide which products or services it feels will be best promoted to and received by the consuming public at any given time using this advertising method. Furthermore, the advertiser 14 may be able to set their pricing structure for photographic prints 22 such that the costs of printing printed advertising indicia 42 are ultimately borne by the customer 18 who elects to purchase a photographic print 22 which contains no advertising indicia.

Various embodiments of a printer device 20 capable of utilizing the printing and advertising methodologies in producing a photographic print 22 are shown in FIGS. 6, 7 and 8. FIG. 6 illustrates one embodiment of the printing method, wherein the printer service 10 may receive the advertising content 12 and the advertiser input 52 from the advertiser 14 in any of a number of formats, including without limitation, on a CD-ROM or other media; on traditional film; by electronic mail or through a website in connection with a global electronic network; in an electronic format or in a verbal or written format. Similarly, the printer service 10 may also receive image data 16 and customer input 52 from a customer 18 in any of a number of formats, including without limitation, on a CD-ROM or other media; on traditional film; by electronic mail or through a website in connection with a global electronic network; in an electronic format or in a verbal or written format. Each of the customer input 50 and the image data 16 are stored within the image data storage unit 26 and each of the advertiser input 52 and the advertising content 12 are stored within the advertising data storage unit 28.

It is understood that any of the advertising content 12, the advertiser input 52, the customer input 50 and the image data 16 are not limited to any specific physical or electronic formats. This printer device 20 is uniquely equipped to receive advertising content 12 and image data 16 in any formats and by any method, thereby giving the printer service 10, the advertiser 14, and the customer 18 certain flexibility and ease of use. In various embodiments shown in FIGS. 6, 7 and 8, the storage of information received from the advertiser 14 and the customer 18 in one of separate image data and advertising data storage units 26, 28; a first single storage unit 70 or second single storage unit 75 allows for the efficient transfer of information during the process of comparing the advertiser input 52 to the customer input 50 to generate at least one match; coupling the related advertising content 12 with the appropriate image data 16 and the subsequent printing of the photographic print 22 by the printer unit 36.

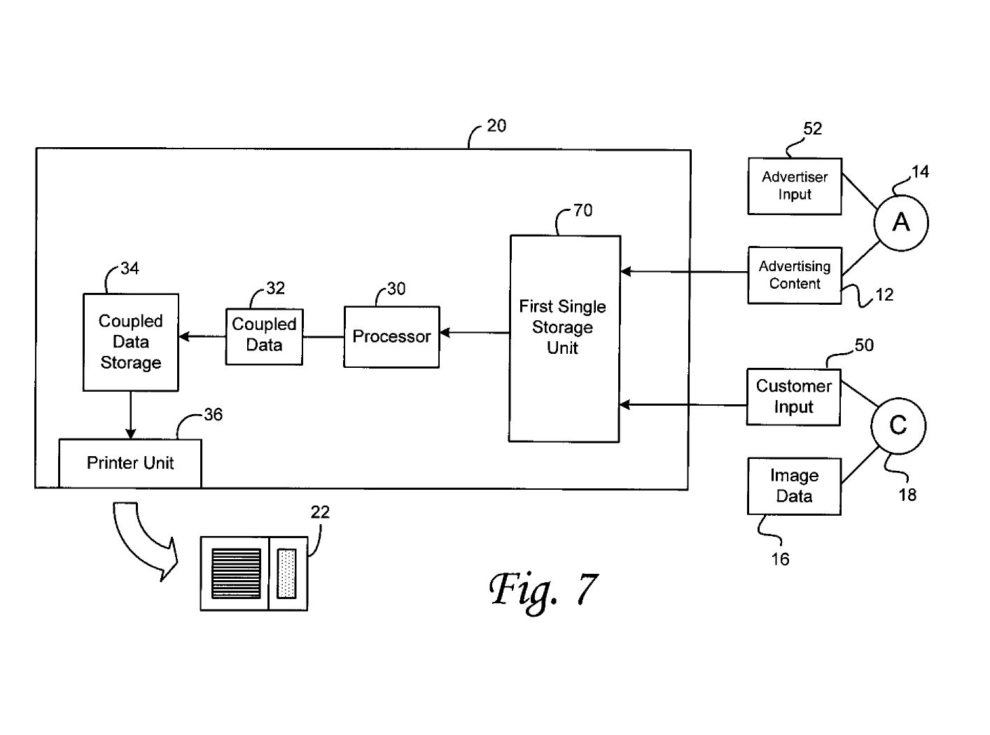

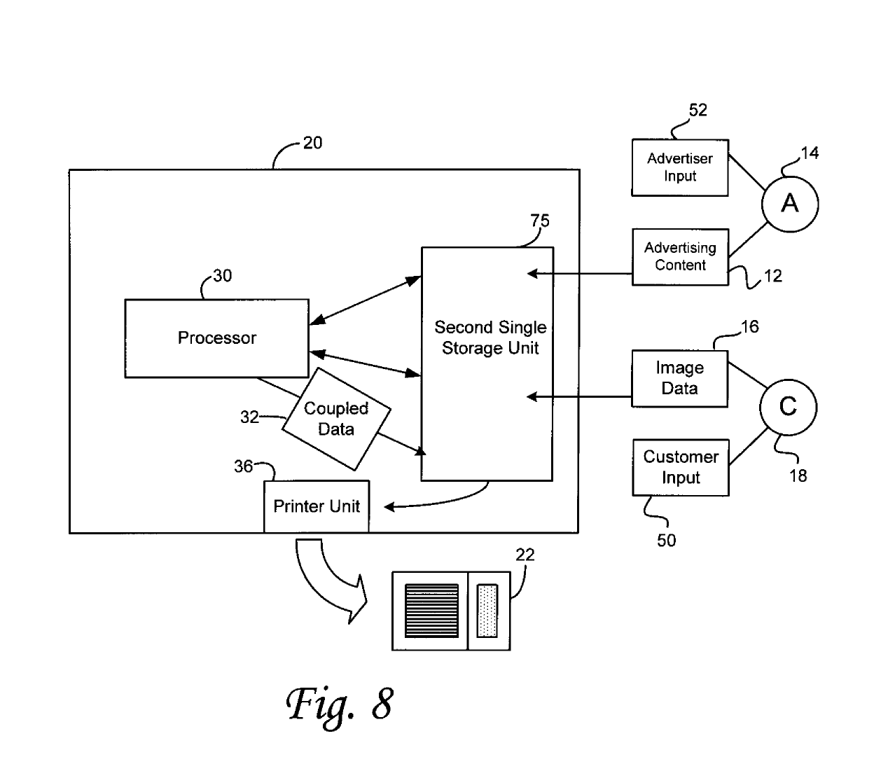

Referring to FIG. 6, the printer device 20 may comprise a separate customer data storage 26 and advertising data storage unit 28 In another embodiment of the printer device 20 shown in FIG. 7, the image data storage unit 26 and the advertising data storage unit 28 are contained in a first single storage unit 70. In yet another embodiment of the printer device 20 shown in FIG. 8, the image data storage unit 26, the advertising data storage unit 28, and the coupled data storage 34 may all be contained in a second single storage unit 75.

Referring to FIGS. 6, 7 and 8, the processor 30 is configured to compare the customer input 50 and the advertiser input 52 to generate at least one match. The processor 30 further generates matching advertising content 12 that is associated with the advertiser input 52 and which is related to the customer input 50. The processor 30 combines the image data 16 from the customer data storage 26 and the advertising content 12 from the advertising data storage unit 28, or from the first single storage unit 70 or the second single storage unit 75, as the case may be, to form coupled data 32 based on the generated matches. Referring to FIGS. 6 and 7, the printer device 20 may further comprise a coupled data storage 34 for the storage of the coupled data 32. The coupled data storage 34 may store coupled data 32 as a designated computer file or in the computer's Random Access Memory (RAM). It is contemplated that in one embodiment of a printer device 20 implementing the printing and advertising methodologies, the coupled data 32 may be stored in the coupled data storage 34 available in a computer's long-term memory. Upon initiation of the printing process, the coupled data 32 stored in such long-term memory may be uploaded to the computer's RAM for printing the photographic print 22 by the printer device 20. In another embodiment of a printer device 20, the coupled data storage 34 containing coupled data 32 may already exist in RAM, thus bypassing the transferring of information from the computer's long-term memory. Under either embodiment, the printer unit 36 then prints the photographic print 22, which includes the printed image 44 and the printed advertising indicia 42. By example, the Noritsu QSS 3001 digital minilab printer is capable of storing coupled data 32 in a computer's long-term memory or in RAM in implementing these methodologies to print a photographic print 22. Referring to FIGS. 6, 7 and 8, the printer device contains a printer unit 36 to print the photographic print 22 derived from the coupled data.

A first embodiment of the photographic print 22 is shown in FIG. 6. The photographic print 22 may be comprised of the printed image 44 on one portion and the printed advertising indicia 42 on another portion. The photographic print 22 may be processed onto any photographic paper stock 21, thereby providing the advertiser 14 with unlimited options in terms of the format in which it wishes to display its printed advertising indicia 42. The printed advertising indicia 42 may for example contain the identification of a retailer, the identification of a product mark, the identification of a product description, or the inclusion of a coupon, depending on the advertising indicia the advertiser 14 desires to promote. The image section 38 and the advertising section are separated by some form of a line indicia 54.

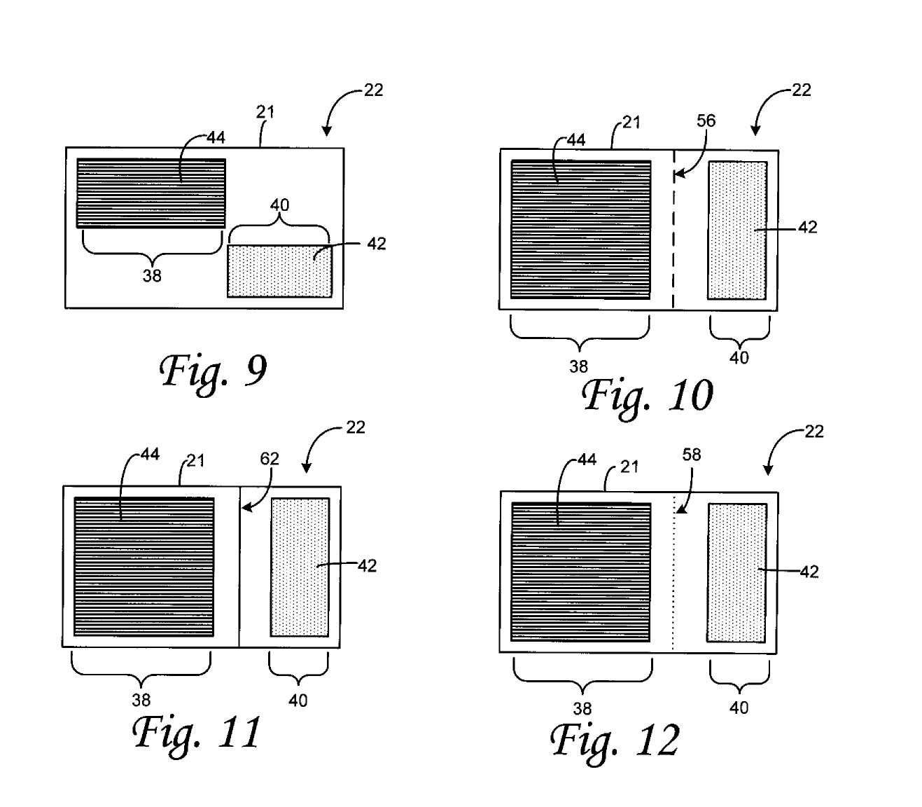

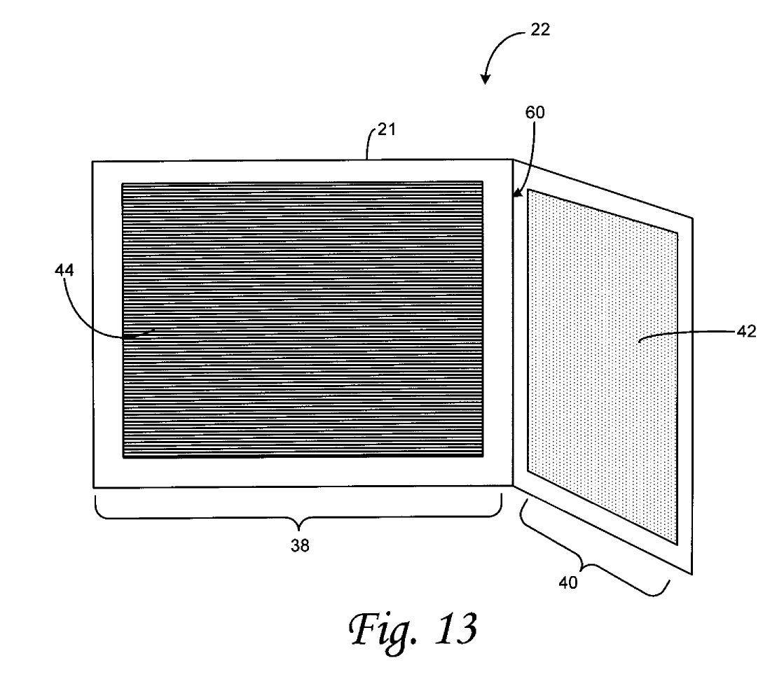

Referring now to FIGS. 9 through 13, there are depicted alternative embodiments of the photographic print 22 which represent the possibilities for placement and separation of the image section 38 and the advertising section 40. While each of the FIGS. 9 through 13 depicts the image section 38 and the advertising section 40 as having some additional separation from the line indicia 54, the image section 38 and the advertising section 40 may in fact be touching or in direct contact with each other. As shown in FIG. 9, the image section 38 and the advertising section 40 may be spaced in any relation to each other. As previously shown in FIG. 6, the photographic paper stock 21 may define a line indicia 54 located between the image section 38 and advertising section 40 along which the customer 18 may remove or detach the printed advertising indicia 42 from the printed image 44. Referring to FIG. 10, the line indicia may be characterized by a dashed line 56 located between the image section 38 and advertising section 40. The customer 18 may separate the image section 38 from the advertising section by cutting along the dashed line 56. In an alternative embodiment depicted in FIG. 11, the advertising section 40 may be detachable from the image section 38 at a solid line 62. Referring to FIG. 12, the line indicia may be defined by a perforation 58 between the image section 38 and advertising section 40 on the photographic print 22. In yet another embodiment depicted in FIG. 13, the line indicia may be defined by a crease 60 between the image section 38 and advertising section 40.

This photographic print 22 may be particularly well adapted to appeal to the customer 18. The embodiment enabling the printed advertising indicia 42 to be detached from the printed image 44 uniquely incentivizes the customer 18 to elect to purchase the photographic print 22 which includes some form of printed advertising indicia 42 that may be one of a promotional or cents-off coupon. The customer 18 may simply remove or detach the printed advertising indicia 42 from the printed image 44. As has been discussed above, the customer 18 is more likely to be a captive audience of advertising if they know that they have the freedom to provide input to facilitate the receipt of certain subjects of printed advertising indicia 42 or whether to view or not view the printed advertising indicia 42. By example, if the customer 18 knows that the time spent viewing advertising indicia 42 on a photographic print 22 may be mitigated by the simple step of removing it from the printed image 44, the customer 18 is far more likely to be accepting of this form of advertising. Should the content of the printed advertising indicia 42 be of interest to the customer 18, such as when the printed advertising indicia 42 is a discount coupon or promotion for a desired good or service, the customer 18 will be encouraged to detach the printed advertising indicia 42 and keep it for future use.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for printing on a photographic print, the method comprising the steps of:
a) receiving advertising content from an advertiser;
b) receiving advertiser input from an advertiser that is associated with the advertising content;
c) receiving image data from a customer;
d) receiving customer input from a customer that is associated with the image data;
e) comparing the customer input to the advertiser input to generate at least one match,
f) combining the advertising content and the image data into coupled data based on the generated match; and
g) printing a photographic print, the photographic print including an image section and an advertising section, the photographic print further including a printed image printed within the image section, the printed image being based upon the image data of the coupled data, the photographic print further including a printed advertising indicia printed within the advertising section, the printed advertising indicia being based upon the advertising content and related to the customer input.

2. The method for printing as claimed in claim 1, wherein the advertiser input comprises one of a keyword, a group of words and a phrase.

3. The method for printing as claimed in claim 1, wherein the advertiser input comprises a format further comprising one of words, responses to a series of prompts or keystrokes.

4. The method for printing as claimed in claim 1, wherein the customer downloads a computer program which is configured to locate image data on a computer for subsequent uploading.

5. The method for printing as claimed in claim 1, wherein the image data contains more than one image.

6. The method for printing as claimed in claim 1, wherein the customer input comprises one of a keyword, a group of words and a phrase.

7. The method for printing as claimed in claim 1, wherein the customer input comprises a format further comprising one of words, responses to a series of prompts or keystrokes.

8. The method for printing as claimed in claim 1, wherein the advertiser input comprises one of a keyword, a group of words and a phrase and the customer input comprises one of a keyword, a group of words and a phrase.

9. The method for printing as claimed in claim 1, wherein the customer input is created by the customer.

10. The method for printing as claimed in claim 1, wherein the customer input is entered into a textbox.

11. The method for printing as claimed in claim 1, wherein the customer input is selected from a subject tree.

12. The method for printing as claimed in claim 1, wherein the customer input further comprises demographic information about the customer.

13. The method for printing as claimed in claim 1, wherein the customer input is associated with the image data in the form of metadata.

14. The method for printing as claimed in claim 1, wherein the customer creates a user profile that is retained by the printer service.

15. The method for printing as claimed in claim 13, wherein the image data and the customer input received by the printer service are associated with the user profile of the customer.

16. The method for printing as claimed in claim 14, wherein the user profile comprises customer input that is compiled over a period of time.

17. A method for advertising on a photographic print, the method comprising the steps of:
a) identifying a printer service, the printer service providing printing services to customers, each customer providing the printer service with image data and customer input that describes the content of the image data, for the printer service to print photographic prints that include printed images derived from the image data;
b) providing advertising content to the printer service, the advertising content being representative of advertising indicia;
c) providing advertiser input to the printer service, the advertiser input associated with the advertising content;
d) requesting the printer service to compare customer input to the advertiser input to generate at least one match; combine the advertising content and the image data into coupled data based on the generated match; and print a photographic print, the photographic print including printed image and an advertising indicia wherein the printed advertising indicia is based upon the advertising content and related to the customer input.

18. The method of advertising claimed in claim 17, further comprising at least two advertisers that want to advertise on exact customer input.

19. The method of advertising claimed in claim 18, further comprising the step of engaging in an auction-style bidding process to advertise on exact customer input.

20. A photographic print comprising:
a photographic paper stock, including an image section and an advertising section;
a printed image printed within the image section; and
a printed advertising indicia printed within the advertising section that is related to the printed image.
